(19) United States
(12) Patent Application Publication
(10) Pub. No.: US 2025/0164901 A1
(43) Pub. Date: May 22, 2025

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: MASASHI NISHI, Kanagawa (JP); TSUTOMU NISHIDA, Shizuoka (JP); AKIHIRO MARUYAMA, Shizuoka (JP); NORIFUMI MURANAKA, Kanagawa (JP)

(21) Appl. No.: 18/941,709

(22) Filed: Nov. 8, 2024

(30) Foreign Application Priority Data
Nov. 16, 2023 (JP) 2023-195285
Oct. 2, 2024 (JP) 2024-173828

(51) Int. Cl. G03G 5/05; G03G 21/18

(52) U.S. Cl. CPC G03G 5/056; G03G 5/0564; G03G 21/1814; G03G 2215/00957

(57) ABSTRACT

Provided is an electrophotographic photosensitive member including: a support; and a photosensitive layer. The photosensitive layer contains a binder resin, a charge generating material, an electron transporting material, and a hole transporting material. The binder resin contains a polyarylate resin having a particular structural unit. The hole transporting material contains a particular compound.

### BACKGROUND OF THE INVENTION

### Field of the Invention

The present invention relates to an electrophotographic photosensitive member, a process cartridge including the electrophotographic photosensitive member, and an electrophotographic apparatus including the electrophotographic photosensitive member.

### Description of the Related Art

In recent years, there has been a demand for an electrophotographic apparatus having a longer service life and being capable of forming an image of higher image quality, and it has been desired to provide an apparatus having high quality stability of an image to be output even at the time of repeated use (hereinafter sometimes referred to as “after endurance”).

An organic electrophotographic photosensitive member (hereinafter sometimes simply referred to as “electrophotographic photosensitive member” or “photosensitive member”) containing an organic photoconductive material (charge generating material) is used as an electrophotographic photosensitive member to be mounted on an electrophotographic apparatus or a process cartridge to be mounted on an electrophotographic apparatus. In the recent electrophotographic apparatus, there has been proposed a technology for improving the durability of various components in order to respond to the above-mentioned longer service life.

For example, in each of Japanese Patent Application Laid-Open Nos. 2022-49733 and 2023-19706, there has been proposed a photosensitive member that uses a polyarylate resin (PAR) excellent in wear resistance as a binder resin in a photosensitive layer.

According to investigations made by the inventors of the present invention, in the photosensitive member described in each of Japanese Patent Application Laid-Open Nos. 2022-49733 and 2023-19706 using a polyarylate resin for the purpose of improving durability, there is room for improvement in suppression of a decrease in sensitivity at the time of repeated use.

### SUMMARY OF THE INVENTION

Thus, an object of the present invention is to provide an electrophotographic photosensitive member, a process cartridge, and an electrophotographic apparatus, which have high durability, and in which a decrease in sensitivity at the time of repeated use is suppressed.

The above-mentioned object is achieved by the present invention to be described below. That is, according to an aspect of the present invention, there is provided an electrophotographic photosensitive member including: a support; and a photosensitive layer, wherein the photosensitive layer contains a binder resin, a charge generating material, an electron transporting material, and a hole transporting material, wherein the binder resin contains a polyarylate resin having a structural unit represented by the following formula (1), a structural unit represented by the following formula (2), a structural unit represented by the following formula (3), and a structural unit represented by the following formula (4):

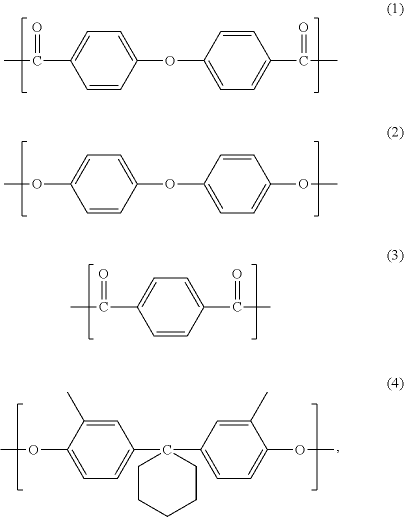

and wherein the hole transporting material contains a compound represented by the following formula (5):

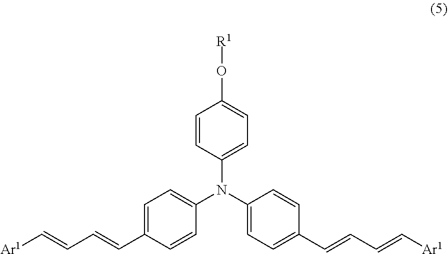

in the formula (5), R¹ represents an alkyl group having 2 or more and 4 or less carbon atoms, and Ar¹ represents an aryl group that may have an alkyl group having 1 or more and 4 or less carbon atoms as a substituent.

Further features of the present invention will become apparent from the following description of exemplary embodiments with reference to the attached drawings.

### BRIEF DESCRIPTION OF THE DRAWINGS

FIG. 1 is a view for illustrating an example of a layer configuration of an electrophotographic photosensitive member according to the present invention.

FIG. 2 is a view for illustrating an example of a layer configuration of the electrophotographic photosensitive member according to the present invention.

FIG. 3 is a view for illustrating an example of a layer configuration of the electrophotographic photosensitive member according to the present invention.

FIG. 4 is a view for illustrating an example of a schematic configuration of an electrophotographic apparatus according to the present invention.

### DESCRIPTION OF THE EMBODIMENTS

The present invention is described below in detail by way of exemplary embodiments.

In the electrophotographic photosensitive member described in each of Japanese Patent Application Laid-Open Nos. 2022-49733 and 2023-19706, a polyarylate resin is used as a binder resin in a photosensitive layer to improve durability. Meanwhile, as a result of investigations made by the inventors, it has been found that, in the electrophotographic photosensitive member described in each of Japanese Patent Application Laid-Open Nos. 2022-49733 and 2023-19706, the sensitivity is low from an initial stage and is further decreased in a process of repeated use. The reason for the foregoing is conceived as described below. Due to the strong resin interaction, the polyarylate resin that contributes to the high durability of the electrophotographic photosensitive member has low compatibility with a hole transporting material and is not appropriately mixed therewith. Thus, the hole extracting ability and hole transporting ability of the hole transporting material are decreased, and holes cannot be allowed to flow smoothly, with the result that the sensitivity is decreased. In addition, it has been found that, in the electrophotographic photosensitive member described in Japanese Patent Application Laid-Open No. 2022-49733, image smearing that is one of image defects is liable to occur through the repeated use. The inventors have assumed the cause for the foregoing to be as described below. The photosensitive layer containing the polyarylate resin has high wear resistance, and hence a discharge product generated on the surface of the photosensitive member cannot be appropriately removed in a cleaning process.

Based on the above-mentioned assumption, the inventors have made various investigations on a measure for suppressing the occurrence of image smearing while keeping high sensitivity in a process of repeated use in a highly durable electrophotographic photosensitive member that uses a polyarylate resin as a binder resin in a photosensitive layer, and as a result, have achieved the present invention.

That is, an electrophotographic photosensitive member according to the present invention includes a support and a photosensitive layer, and the photosensitive layer contains a binder resin, a charge generating material, an electron transporting material, and a hole transporting material. In addition, the binder resin contains a polyarylate resin having a structural unit represented by the following formula (1), a structural unit represented by the following formula (2), a structural unit represented by the following formula (3), and a structural unit represented by the following formula (4).

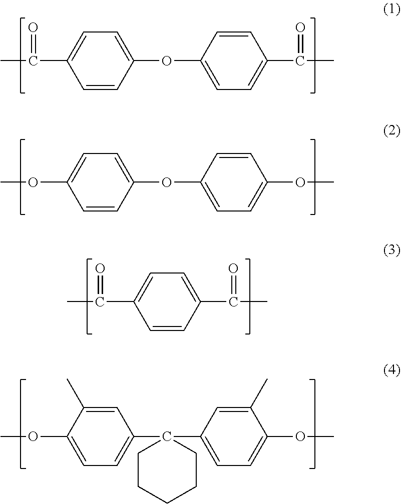

In addition, the hole transporting material contains a compound represented by the following formula (5).

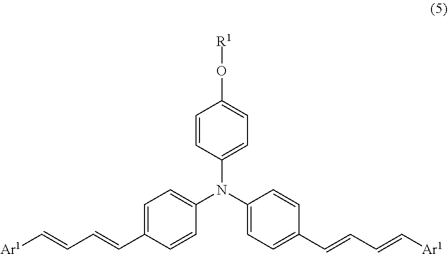

In the formula (5), R¹ represents an alkyl group having 2 or more and 4 or less carbon atoms, and Ar¹ represents an aryl group that may have an alkyl group having 1 or more and 4 or less carbon atoms as a substituent.

The inventors have found that, when the electrophotographic photosensitive member has the above-mentioned configuration according to the present invention, high sensitivity can be kept in a process of repeated use, and the occurrence of image smearing can be suppressed while high durability is achieved.

The inventors have assumed the reason for the foregoing to be described below. Due to the strong resin interaction, the polyarylate resin having the respective structural units represented by the formulae (1), (2), (3), and (4) has low compatibility with a hole transporting material that has few heteroatoms in the molecule and has low polarity. However, the hole transporting material represented by the formula (5) has a para-phenoxy structure, and hence such hole transporting material has high compatibility with the polyarylate resin and simultaneously has a low ionization potential. From the foregoing, the hole transporting material represented by the formula (5) has an improved hole extracting ability. Thus, holes flow smoothly without retention, and high sensitivity can be kept in a process of repeated use. In addition, the high degree of compatibility between the above-mentioned polyarylate resin and hole transporting material suppresses micro electrical resistance unevenness on the surface of the photosensitive member. Thus, the discharge becomes uniform, and the generation of a discharge product by a localized large current caused by discharge unevenness can be suppressed. As a result, the occurrence of image smearing can be suppressed.

The configuration of the electrophotographic photosensitive member according to the present invention is described below in more detail.

### [Electrophotographic Photosensitive Member]

The electrophotographic photosensitive member according to the present invention includes a support and a photosensitive layer formed on the support.

A method of producing the electrophotographic photosensitive member according to the present invention is, for example, a method involving: preparing coating liquids for the respective layers to be described later; applying the liquids in a desired order of the layers; and drying the liquids. In this case, examples of the method of applying the coating liquid include dip coating, spray coating, inkjet coating, roll coating, die coating, blade coating, curtain coating, wire bar coating, and ring coating. Of those, dip coating is preferred from the viewpoints of efficiency and productivity.

### (Monolayer Type Photosensitive Member)

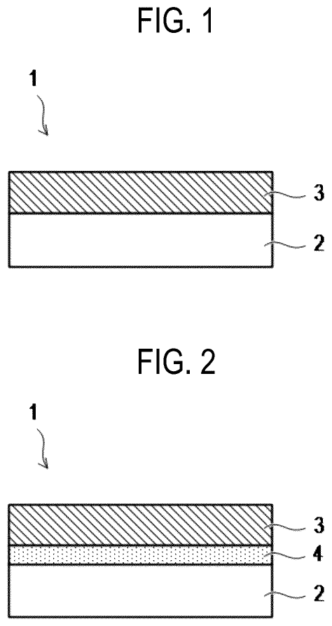

A monolayer type photosensitive member 1 according to an embodiment of the present invention is described below with reference to FIG. 1 to FIG. 3. FIG. 1 to FIG. 3 are each a partial sectional view for illustrating an example of a layer configuration of the monolayer type photosensitive member 1.

As illustrated in FIG. 1, the monolayer type photosensitive member 1 includes, for example, an electroconductive support 2 and a photosensitive layer 3. The photosensitive layer 3 included in the monolayer type photosensitive member 1 is a monolayer type photosensitive layer of a monolayer (one layer). The photosensitive layer 3 contains a binder resin, a charge generating material, an electron transporting material, and a hole transporting material.

As illustrated in FIG. 2, the monolayer type photosensitive member 1 may further include an undercoat layer 4 (intermediate layer) in addition to the support 2 and the photosensitive layer 3. That is, in the monolayer type photosensitive member 1, the photosensitive layer 3 may be formed directly on the support 2 or may be formed on the support 2 through intermediation of the undercoat layer 4 as illustrated in FIG. 2.

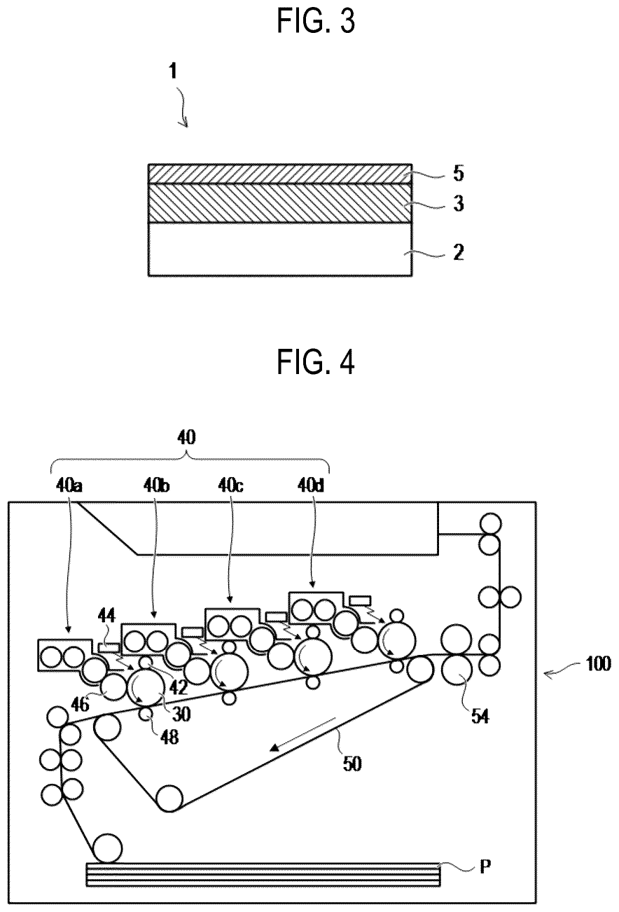

In addition, as illustrated in FIG. 3, the monolayer type photosensitive member 1 may further include a protection layer 5 in addition to the support 2 and the photosensitive layer 3. The protection layer 5 is formed on the photosensitive layer 3. In the present invention, as illustrated in each of FIG. 1 and FIG. 2, it is preferred that the monolayer type photosensitive member 1 do not include the protection layer 5 and the photosensitive layer 3 be formed as a surface layer of the monolayer type photosensitive member 1. When the photosensitive layer 3 containing, as a binder resin, the polyarylate resin (PAR) having the respective structural units represented by the formulae (1) to (4) is formed as a surface layer, the effects of the present invention are easily obtained at the time of repeated use.

The thickness of the photosensitive layer 3 is not particularly limited, but is preferably 5 μm or more and 100 μm or less, more preferably 10 μm or more and 50 μm or less.

### <Support>

In the present invention, the electrophotographic photosensitive member includes the support. In the present invention, the support is preferably an electroconductive support having electroconductivity. In addition, examples of the shape of the support include a cylindrical shape, a belt shape, and a sheet shape. A support having a cylindrical shape out of those shapes is preferred. In addition, the surface of the support may be subjected to, for example, electrochemical treatment such as anodization, blast treatment, or cutting treatment.

A metal, a resin, glass, or the like is preferred as a material for the support.

Examples of the metal include aluminum, iron, nickel, copper, gold, stainless steel, and alloys thereof. An aluminum support using aluminum out of those metals is preferred.

In addition, electroconductivity may be imparted to the resin or the glass through treatment involving, for example, mixing or coating the resin or the glass with an electroconductive material.

### <Undercoat Layer>

In the present invention, an undercoat layer may be arranged on the support. The arrangement of the undercoat layer can improve an adhesive function between layers to impart a charge injection inhibiting function.

The undercoat layer preferably contains a resin. In addition, the undercoat layer may be formed as a cured film by polymerizing a composition containing a monomer having a polymerizable functional group.

Examples of the resin include a polyester resin, a polyarylate resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having the polymerizable functional group include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group, and a carbon-carbon double bond group.

In addition, the undercoat layer may further contain an electron transporting material, a metal oxide, a metal, an electroconductive polymer, and the like for the purpose of improving electric characteristics. Of those, an electron transporting material and a metal oxide are preferably used.

Examples of the electron transporting material include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron transporting material having a polymerizable functional group may be used as the electron transporting material and copolymerized with the above-mentioned monomer having a polymerizable functional group to form the undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

In addition, the undercoat layer may further contain an additive.

The thickness of the undercoat layer is preferably from 0.1 μm to 50 μm, more preferably from 0.2 μm to 40 μm, particularly preferably from 0.3 μm to 30 μm.

The undercoat layer may be formed by: preparing a coating liquid for an undercoat layer containing the above-mentioned respective materials and a solvent; forming a coating film of the coating liquid; and drying and/or curing the coating film. Examples of the solvent to be used in the coating liquid include an alcohol-based solvent, a ketone-based solvent, an ether-based solvent, an ester-based solvent, and an aromatic hydrocarbon-based solvent.

### <Monolayer Type Photosensitive Layer>

The electrophotographic photosensitive member according to the present invention includes the monolayer type photosensitive layer arranged on the support, or on the undercoat layer arranged on the support.

In the present invention, the monolayer type photosensitive layer contains a binder resin, a charge generating material, a hole transporting material, and an electron transporting material.

### [Binder Resin]

The binder resin to be used in the photosensitive layer contains a polyarylate resin having a structural unit represented by the following formula (1), a structural unit represented by the following formula (2), a structural unit represented by the following formula (3), and a structural unit represented by the following formula (4).

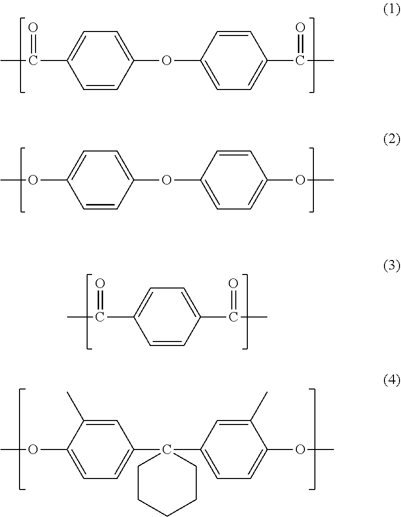

The above-mentioned polyarylate resin may be, for example, a random copolymer, an alternating copolymer, a periodic copolymer, or a block copolymer.

In the above-mentioned polyarylate resin, the ratio of the substance amount of the structural unit represented by the formula (1) to the total substance amount of the structural units for forming the polyarylate resin is represented by M1. In addition, the ratio of the substance amount of the structural unit represented by the formula (2) to the total substance amount of the structural units for forming the polyarylate resin is represented by M2. In addition, the ratio of the substance amount of the structural unit represented by the formula (3) to the total substance amount of the structural units for forming the polyarylate resin is represented by M3. In addition, the ratio of the substance amount of the structural unit represented by the formula (4) to the total substance amount of the structural units for forming the polyarylate resin is represented by M4. In this case, M1/(M1+M3) is preferably 0.30 or more, more preferably 0.55 or more from the viewpoint of improving wear resistance.

In addition, M2/(M2+M4) is preferably larger from the viewpoint of improving wear resistance, and specifically, is preferably 0.10 or more. In addition, M2/(M2+M4) is preferably less than 0.50 from the viewpoint of solubility in a solvent. When the solubility in a solvent is improved, a photosensitive layer can be satisfactorily formed. Thus, M2/(M2+M4) is preferably 0.10 or more and less than 0.50.

In addition, M3/(M1+M3) is preferably 0.30 or more and less than 0.70 from the viewpoint of suppressing a decrease in sensitivity.

In addition, M4/(M2+M4) is preferably less than 0.90 from the viewpoint of improving solubility in a solvent.

In the above-mentioned polyarylate resin, the sum of the ratio of the substance amount of the structural unit represented by the formula (1) and the ratio of the substance amount of the structural unit represented by the formula (3) is preferably 0.30 or more, more preferably 0.50 or more with respect to the total substance amount of structural units derived from dicarboxylic acids for forming the polyarylate resin.

In the above-mentioned polyarylate resin, the sum of the ratio of the substance amount of the structural unit represented by the formula (2) and the ratio of the substance amount of the structural unit represented by the formula (4) is preferably more than 0 and 0.50 or less with respect to the total substance amount of structural units derived from bisphenols for forming the polyarylate resin.

In addition, the ratio of the substance amount of the structural unit represented by the formula (1) is preferably 0.5 or more with respect to the total substance amount of structural units derived from dicarboxylic acids for forming the above-mentioned polyarylate resin.

In addition, in the electrophotographic photosensitive member according to the present invention, the ratio of the mass of the above-mentioned polyarylate resin to the total mass of the binder resin is preferably 50 mass % or more.

The viscosity-average molecular weight of the above-mentioned polyarylate resin (PAR) is preferably 10,000 or more, more preferably 30,000 or more, still more preferably 50,000 or more. When the viscosity-average molecular weight of the above-mentioned polyarylate resin (PAR) is 10,000 or more, the wear resistance of the photosensitive member is improved. Meanwhile, the viscosity-average molecular weight of the above-mentioned polyarylate resin (PAR) is preferably 80,000 or less, more preferably 70,000 or less. When the viscosity-average molecular weight of the above-mentioned polyarylate resin (PAR) is 80,000 or less, the above-mentioned polyarylate resin (PAR) is easily dissolved in a solvent for forming a photosensitive layer.

Examples of the bisphenols for forming bisphenol-derived repeating units in the above-mentioned polyarylate resin include a compound represented by the following formula (BP-1) and a compound represented by the following formula (BP-2). The compound represented by the following formula (BP-1) is hereinafter sometimes referred to as “compound (BP-1).” In addition, the compound represented by the following formula (BP-2) is hereinafter sometimes referred to as “compound (BP-2).”

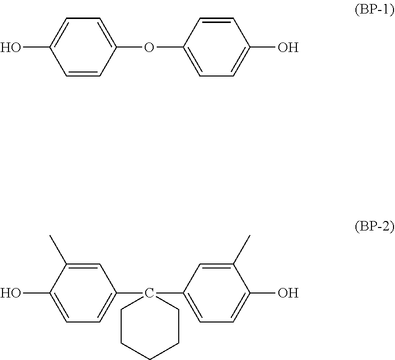 [SMILES: Oc1ccc(Oc2ccc(O)cc2)cc1 ; Cc1cc(C2(c3ccc(O)c(C)c3)CCCCC2)ccc1O]

In addition, examples of the dicarboxylic acids for forming dicarboxylic acid-derived repeating units in the above-mentioned polyarylate resin include a compound represented by the following formula (DC-1) and a compound represented by the following formula (DC-2). The compound represented by the following formula (DC-1) is hereinafter sometimes referred to as “compound (DC-1).” In addition, the compound represented by the following formula (DC-2) is hereinafter sometimes referred to as “compound (DC-2).”

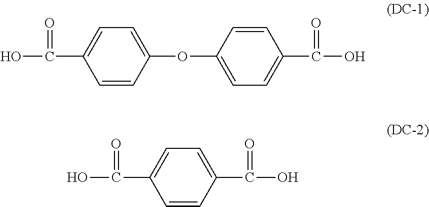 [SMILES: O=C(O)c1ccc(Oc2ccc(C(=O)O)cc2)cc1 ; O=C(O)c1ccc(C(=O)O)cc1]

A bisphenol ratio in the resin may be adjusted by changing the amounts of the compound (BP-1) and the compound (BP-2) to be added at the time of production of the above-mentioned polyarylate resin (PAR). In addition, a dicarboxylic acid ratio in the resin may be similarly adjusted by changing the amounts of the compound (DC-1) and the compound (DC-2) to be added at the time of production of the above-mentioned polyarylate resin (PAR).

The bisphenols (e.g., the compounds (BP-1) and (BP-2)) may each be used by being derivatized into an aromatic diacetate. The dicarboxylic acids (e.g., the compounds (DC-1) and (DC-2)) may each be used by being derivatized. Examples of the derivative of the dicarboxylic acid include a dicarboxylic acid dichloride, a dicarboxylic acid dimethyl ester, a dicarboxylic acid diethyl ester, and a dicarboxylic acid anhydride. The dicarboxylic acid dichloride is a compound having a structure in which two “—C(═O)—OH” groups of the dicarboxylic acid are each substituted with a “—C(═O)—Cl” group.

In the polycondensation of the bisphenol and the dicarboxylic acid, one or both of a base and a catalyst may be added. An example of the base is sodium hydroxide. Examples of the catalyst include benzyltributylammonium chloride, ammonium chloride, ammonium bromide, a quaternary ammonium salt, triethylamine, and trimethylamine.

The photosensitive layer may contain, as the binder resin, only the above-mentioned polyarylate resin (PAR), and may further contain a binder resin other than the foregoing (hereinafter sometimes referred to as “other binder resin”). When the photosensitive layer contains the other binder resin in addition to the above-mentioned polyarylate resin, the ratio of the mass of the above-mentioned polyarylate resin to the total mass of the binder resins in the photosensitive layer is preferably 0.8 or more.

Examples of the other binder resin include: thermoplastic resins (more specifically, a polyarylate resin other than the above-mentioned polyarylate resin (PAR), a polycarbonate resin, a styrene-based resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diallyl phthalate resin, a ketone resin, a polyvinyl butyral resin, a polyvinyl acetal resin, and a polyether resin); thermosetting resins (more specifically, a silicone resin, an epoxy resin, a phenol resin, a urea resin, a melamine resin, and any other crosslinkable thermosetting resin); and photocurable resins (more specifically, an epoxy-acrylic acid-based resin and a urethane-acrylic acid-based copolymer).

The structure of the polyarylate resin to be used in the present invention may be determined by a ¹H-nuclear magnetic resonance spectrum obtained by subjecting polymer components recovered from the photosensitive layer to ¹H-nuclear magnetic resonance spectrometry in deuterated chloroform.

An example of a specific analysis method for the polyarylate resin in the photosensitive layer when the photosensitive member is a cylindrical body is described below.

### (Reprecipitation of Resin in Photosensitive Layer)

The photosensitive member is cut at a position 10 cm distant from an end portion of the photosensitive member in a generating line direction with a scroll saw.
An inner surface of the cut cylindrical body of 10 cm is wiped with lens cleaning paper impregnated with chloroform.
To elute the photosensitive layer, 3 cm of an end portion of the cut cylindrical body is immersed in chloroform. (About 60 ml of chloroform is loaded into a 100 ml beaker, and the end portion is immersed therein at normal temperature for 5 minutes.)
The chloroform solution in which the above-mentioned photosensitive layer has been eluted is concentrated to 2 mL with a rotary evaporator, and the concentration is stopped . . . 50 mL of a methanol/acetone mixed solution (volume ratio: 1:1) is prepared, and the whole amount of the above-mentioned concentrated solution is dropped thereinto while the mixed solution is stirred, to thereby perform reprecipitation.
Suction filtration is performed with a funnel (funnel: SU-40, paper filter: No. 5C-40, manufactured by Kiriyama Glass Co.).
The residue on the paper filter is recovered with a spatula and dried in a vacuum (70° C., 1 hour).

### (NMR Measurement)

To prepare a measurement sample, 20 mg of a sample is dissolved in 1 g of deuterated chloroform containing tetramethylsilane serving as a reference material, and the whole amount thereof is transferred to an NMR tube.
(Deuterated chloroform: manufactured by Sigma-Aldrich Japan G.K., chloroform-d, model number: 612200)
(NMR tube: manufactured by Norell, Inc., ST500-7, model number: S3010)
NMR measurement is performed.
   Apparatus: AVANCE 500 manufactured by Bruker
   Conditions: Proton NMR, automatic measurement by Icon-NMR
   Number of scans: 32
   Reference peak: The peak of a methyl group of tetramethylsilane is set to 0 ppm.

### [Hole Transporting Material]

The hole transporting material contains a compound represented by the following formula (5).

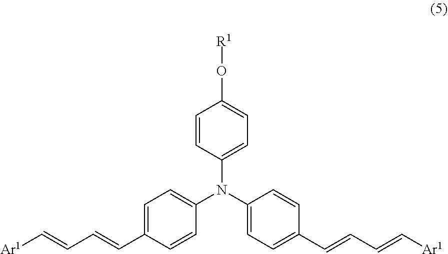

In the formula (5), R¹ represents an alkyl group having 2 or more and 4 or less carbon atoms, and Ar¹ represents an aryl group that may have an alkyl group having 1 or more and 4 or less carbon atoms as a substituent.

Examples of the alkyl group represented by R¹ in the formula (5) include an ethyl group, a n-propyl group, an isopropyl group, a n-butyl group, an isobutyl group, a sec-butyl group, and a tert-butyl group.

Ar¹ in the formula (5) preferably represents a phenyl group that may have an alkyl group as a substituent. The number of substituents of the aryl group represented by Ar¹ in the formula (5) is preferably 0 or 1, more preferably 0. Examples of the substituents of the aryl group represented by Ar¹ in the formula (5) include a methyl group, an ethyl group, a n-propyl group, an isopropyl group, a n-butyl group, an isobutyl group, a sec-butyl group, and a tert-butyl group.

Suitable examples of the compound represented by the formula (5) include compounds shown in Table 1. The compounds represented by the formula (5) shown as examples in Table 1 are hereinafter sometimes referred to as “hole transporting materials (H-1) to (H-10),” respectively.

Regarding the compound represented by the formula (5), a ¹H-NMR spectrum may be obtained by ¹H-nuclear magnetic resonance spectrometry in a solvent such as deuterated chloroform. As a result, the structure represented by the formula (5) can be identified.

TABLE 1

| Hole | | |
|---|---|---|
| transporting | | |
| material | R¹ | Ar¹ |
| H-1 | Et | 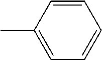 |
| H-2 | n-Pr | 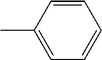 |
| H-3 | i-Pr | 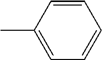 |
| H-4 | n-Bu | 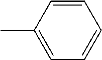 |
| H-5 | t-Bu | 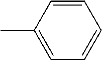 |
| H-6 | Et | 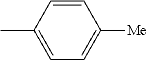 |
| H-7 | n-Pr | 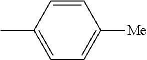 |
| H-8 | Et | 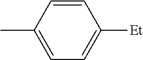 |
| H-9 | i-Pr | 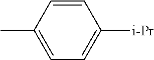 |
| H-10 | n-Bu | 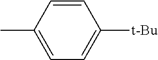 |

In Table 1, Me represents a methyl group, Et represents an ethyl group, n-Pr represents a n-propyl group, i-Pr represents an isopropyl group, n-Bu represents a n-butyl group, and t-Bu represents a tert-butyl group.

The content of the hole transporting material in the photosensitive layer is preferably 10 parts by mass or more and 200 parts by mass or less, more preferably 30 parts by mass or more and 120 parts by mass or less, still more preferably 50 parts by mass or more and 90 parts by mass or less with respect to 100 parts by mass of the binder resin.

The photosensitive layer may further contain one or more kinds of hole transporting materials other than the compound represented by the formula (5) (hereinafter sometimes referred to as “other hole transporting materials”). Examples of the other hole transporting material include a triphenylamine derivative, a diamine derivative (e.g., an N,N,N′,N′-tetraphenylbenzidine derivative, an N,N,N′,N′-tetraphenylphenylenediamine derivative, an N,N,N′,N′-tetraphenylnaphthylenediamine derivative, an N,N,N′,N′-tetraphenylphenanthrenediamine derivative, and a di(aminophenylethenyl)benzene derivative), an oxadiazole-based compound (e.g., 2,5-di(4-methylaminophenyl)-1,3,4-oxadiazole), a styryl-based compound (e.g., 9-(4-diethylaminostyryl)anthracene), a carbazole-based compound (e.g., polyvinyl carbazole), an organic polysilane compound, a pyrazoline-based compound (e.g., 1-phenyl-3-(p-dimethylaminophenyl)pyrazoline), a hydrazone-based compound, an indole-based compound, an oxazole-based compound, an isooxazole-based compound, a thiazole-based compound, a thiadiazole-based compound, an imidazole-based compound, a pyrazole-based compound, and a triazole-based compound.

It is preferred that the ratio of the substance amount of the compound represented by the formula (5) in the photosensitive layer to the total substance amount of all of the hole transporting materials in the photosensitive layer be 0.6 or more.

It is preferred that the ratio of the compound represented by the formula (5) in the photosensitive layer to the content of all of the hole transporting materials in the photosensitive layer be 50 mass % or more.

### [Charge Generating Material]

Examples of the charge generating material include a phthalocyanine-based pigment, a perylene-based pigment, a bisazo pigment, a trisazo pigment, a dithioketopyrrolopyrrole pigment, a metal-free naphthalocyanine pigment, a metal naphthalocyanine pigment, a squaraine pigment, an indigo pigment, an azulenium pigment, a cyanine pigment, powder of an inorganic photoconductive material (e.g., selenium, selenium-tellurium, selenium-arsenic, cadmium sulfide, and amorphous silicon), a pyrylium pigment, an anthanthrone-based pigment, a triphenylmethane-based pigment, a threne-based pigment, a toluidine-based pigment, a pyrazoline-based pigment, and a quinacridone-based pigment. The photosensitive layer may contain only one kind of charge generating material, or may contain two or more kinds of charge generating materials.

The phthalocyanine-based pigment is a pigment having a phthalocyanine structure. Examples of the phthalocyanine-based pigment include metal-free phthalocyanine and a metal phthalocyanine. Examples of the metal phthalocyanine include titanyl phthalocyanine, hydroxygallium phthalocyanine, and chlorogallium phthalocyanine. The metal phthalocyanine is preferably titanyl phthalocyanine. Titanyl phthalocyanine is represented by the following formula (CGM-1).

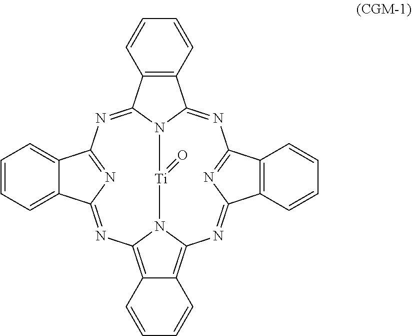

The phthalocyanine-based pigment may be crystalline or amorphous. An example of the crystal of metal-free phthalocyanine is an X-form crystal of metal-free phthalocyanine (hereinafter sometimes referred to as “X-form metal-free phthalocyanine”). Examples of the crystal of titanyl phthalocyanine include α-form, β-form, and Y-form crystals of titanyl phthalocyanine (hereinafter sometimes referred to as “α-form, β-form, and Y-form titanyl phthalocyanines,” respectively). For example, in a digital optical electrophotographic apparatus (e.g., a laser beam printer or a facsimile using a light source such as a semiconductor laser), a photosensitive member having sensitivity in a wavelength region of 700 nm or more is preferably used. The charge generating material is preferably a phthalocyanine-based pigment, more preferably metal-free phthalocyanine or titanyl phthalocyanine, because these materials each have a high quantum yield in a wavelength region of 700 nm or more. In addition, the charge generating material is still more preferably titanyl phthalocyanine, particularly preferably Y-form titanyl phthalocyanine.

The Y-form titanyl phthalocyanine does not have a peak at 26.2°, and has a main peak, for example, at a Bragg angle (2θ±0.2°) of 27.2° in a CuKα characteristic X-ray diffraction spectrum. The main peak in the CuKα characteristic X-ray diffraction spectrum is a peak having the first or second largest intensity in the range of a Bragg angle (2θ±0.2°) of 3° or more and 40° or less.

The CuKα characteristic X-ray diffraction spectrum may be measured, for example, by the following method. First, a sample (titanyl phthalocyanine) is loaded into a sample holder of an X-ray diffraction apparatus (e.g., “RINT (trademark) 1100” manufactured by Rigaku Corporation). Subsequently, an X-ray diffraction spectrum is measured under the conditions of an X-ray tube bulb of Cu, a tube voltage of 40 kV, a tube current of 30 mA, and a CuKα characteristic X-ray wavelength of 1.542 Å. A measurement range (2θ) is, for example, 3° or more and 40° or less (start angle: 3° and stop angle: 40°), and a scanning speed is, for example, 10°/min. The main peak is determined from the resultant X-ray diffraction spectrum, and the Bragg angle of the main peak is read.

The content of the charge generating material in the photosensitive layer is preferably 0.1 part by mass or more and 50 parts by mass or less, more preferably 0.5 part by mass or more and 15 parts by mass or less with respect to 100 parts by mass of the binder resin.

### [Electron Transporting Material]

It is preferred that the electron transporting material contain at least one compound selected from the group consisting of: a compound represented by the following formula (6); a compound represented by the following formula (7); a compound represented by the following formula (8); a compound represented by the following formula (9); a compound represented by the following formula (10); a compound represented by the following formula (11); and a compound represented by the following formula (12). It is conceived that, when the photosensitive layer contains the above-mentioned electron transporting material, the compatibility between the above-mentioned polyarylate resin and the compound represented by the formula (5) is increased to enhance the uniformity in the photosensitive layer, and thus the effects of the present invention are highly achieved.

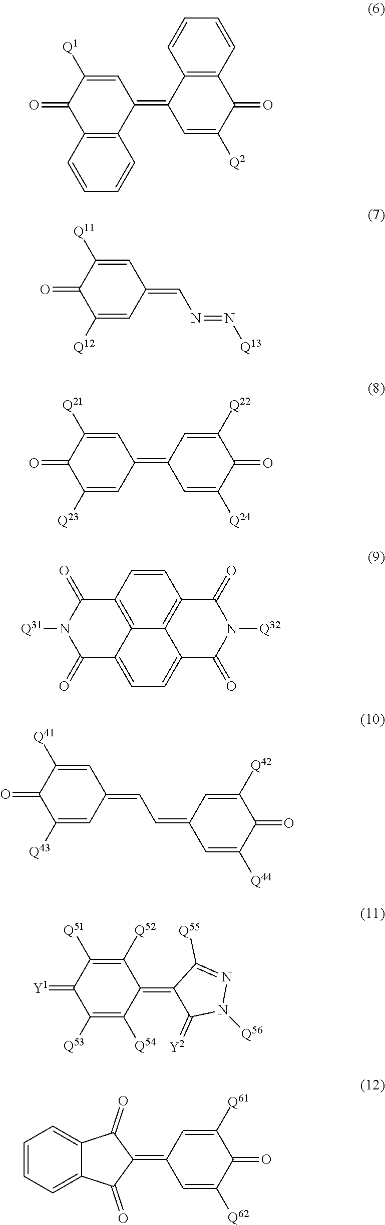

Q¹ and Q² in the formula (6), Q¹¹, Q¹², and Q¹³ in the formula (7), Q²¹, Q²², Q²³, and Q²⁴ in the formula (8), Q³¹ and Q³² in the formula (9), Q⁴¹, Q⁴², Q⁴³, and Q⁴⁴ in the formula (10), Q⁵¹, Q⁵², Q⁵³, Q⁵⁴, Q⁵⁵, and Q⁵⁶ in the formula (11), and Q⁶¹ and Q⁶² in the formula (12) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group having 6 or more and 14 or less carbon atoms that may be substituted with at least one substituent selected from the group consisting of: an alkyl group having 1 or more and 6 or less carbon atoms; and a halogen atom. Y¹ and Y² in the formula (11) each independently represent an oxygen atom or a sulfur atom.

It is preferred that Q¹ and Q² in the formula (6), Q¹¹ to Q¹³ in the formula (7), Q²¹ to Q²⁴ in the formula (8), Q³¹ and Q³² in the formula (9), Q⁴¹ to Q⁴⁴ in the formula (10), Q⁵¹ to Q⁵⁶ in the formula (11), and Q⁶¹ and Q⁶² in the formula (12) each independently represent a hydrogen atom, an alkyl group having 1 or more and 6 or less carbon atoms, or an aryl group having 6 or more and 14 or less carbon atoms that may be substituted with at least one substituent selected from the group consisting of: an alkyl group having 1 or more and 6 or less carbon atoms; and a halogen atom. It is preferred that Y¹ and Y² in the formula (11) each represent an oxygen atom.

The alkyl group having 1 or more and 6 or less carbon atoms, which is represented by each of Q¹ and Q² in the formula (6), Q¹¹ to Q¹³ in the formula (7), Q²¹ to Q²⁴ in the formula (8), Q³¹ and Q³² in the formula (9), Q⁴¹ to Q⁴⁴ in the formula (10), Q⁵¹ to Q⁵⁶ in the formula (11), and Q⁶¹ and Q⁶² in the formula (12), is preferably an alkyl group having 1 or more and 5 or less carbon atoms, preferably a methyl group, an ethyl group, a propyl group, a butyl group, or a pentyl group, particularly preferably a methyl group, an isopropyl group, a tert-butyl group, or a 1,1-dimethylpropyl group.

The aryl group having 6 or more and 14 or less carbon atoms, which is represented by each of Q¹ and Q² in the formula (6), Q¹¹ to Q¹³ in the formula (7), Q²¹ to Q²⁴ in the formula (8), Q³¹ and Q³² in the formula (9), Q⁴¹ to Q⁴⁴ in the formula (10), Q⁵¹ to Q⁵⁶ in the formula (11), and Q⁶¹ and Q⁶² in the formula (12), is preferably an aryl group having 6 or more and 10 or less carbon atoms, more preferably a phenyl group.

Here, the alkyl group having 1 or more and 6 or less carbon atoms that the aryl group having 6 or more and 14 or less carbon atoms may have as a substituent is preferably an alkyl group having 1 or more and 3 or less carbon atoms, more preferably a methyl group or an ethyl group.

In addition, the halogen atom that the aryl group having 6 or more and 14 or less carbon atoms may have as a substituent is preferably a fluorine atom, a chlorine atom, or a bromine atom, particularly preferably a chlorine atom.

When the aryl group having 6 or more and 14 or less carbon atoms is substituted with a substituent, the number of substituents is preferably 1 or more and 5 or less, more preferably 1 or 2.

The aryl group having 6 or more and 14 or less carbon atoms that is substituted with at least one substituent selected from the group consisting of: an alkyl group having 1 or more and 6 or less carbon atoms; and a halogen atom is preferably a chlorophenyl group, a dichlorophenyl group, or an ethylmethylphenyl group, more preferably a 4-chlorophenyl group, a 2,5-dichlorophenyl group, or a 2-ethyl-6-methylphenyl group.

A suitable example of the compound represented by the formula (6) is a compound represented by the following formula (E-4). A suitable example of the compound represented by the formula (7) is a compound represented by the following formula (E-5). A suitable example of the compound represented by the formula (8) is a compound represented by the following formula (E-7). A suitable example of the compound represented by the formula (9) is a compound represented by the following formula (E-6). A suitable example of the compound represented by the formula (10) is a compound represented by the following formula (E-8). Suitable examples of the compound represented by the formula (11) include a compound represented by the following formula (E-2) and a compound represented by the following formula (E-3). A suitable example of the compound represented by the formula (12) is a compound represented by the following formula (E-1). The compounds represented by the formulae (E-1) to (E-8) are sometimes referred to as “electron transporting materials (E-1) to (E-8),” respectively.

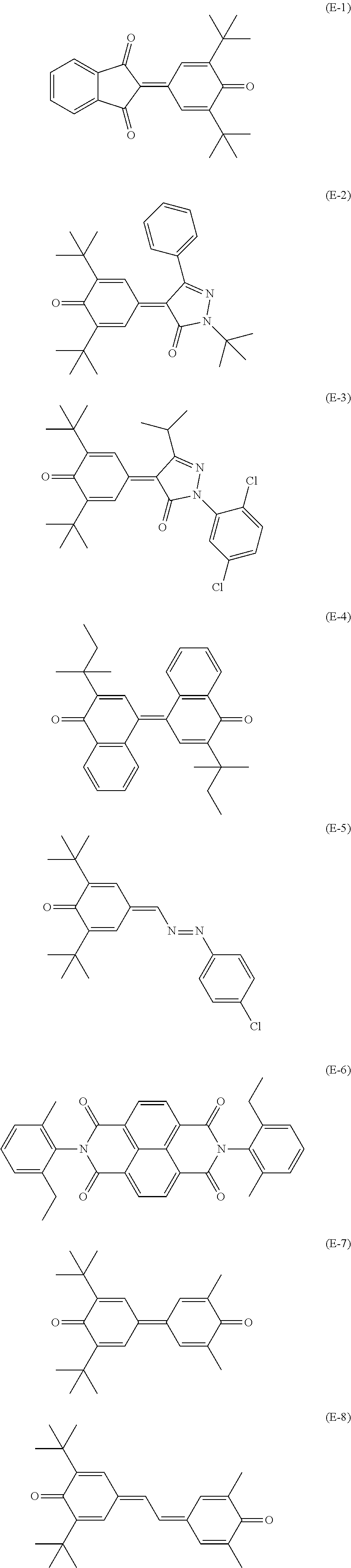

The content of the electron transporting material in the photosensitive layer is preferably 5 parts by mass or more and 150 parts by mass or less, more preferably 10 parts by mass or more and 100 parts by mass or less, still more preferably 30 parts by mass or more and 70 parts by mass or less with respect to 100 parts by mass of the binder resin. The photosensitive layer may contain only one kind of electron transporting material, or may contain two or more kinds of electron transporting materials.

### [Additive]

The photosensitive layer may contain an additive as required. Examples of the additive include a UV absorber, an antioxidant, a radical scavenger, a singlet quencher, a softener, a surface modifier, an extender, a thickener, a wax, a donor, a surfactant, a plasticizer, a sensitizer, and a leveling agent. In particular, it is preferred that the photosensitive layer contain at least one compound selected from the group consisting of: a compound represented by the following formula (T-1); a compound represented by the following formula (T-2); a compound represented by the following formula (T-3); and a compound represented by the following formula (T-4). “t-Bu” in each of the formulae (T-2), (T-3), and (T-4) represents a tert-butyl group.

The content ratio of the additive in the photosensitive layer is preferably 0.1 mass % or more and 10 mass % or less with respect to the total mass of the photosensitive layer.

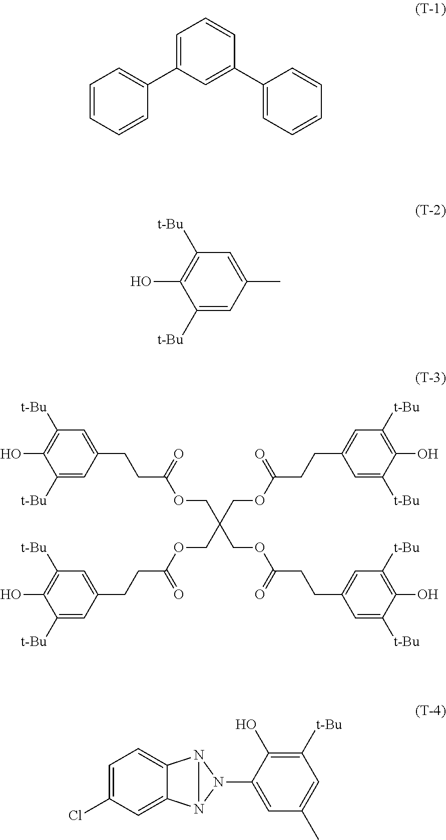

Subsequently, a process cartridge and an electrophotographic apparatus according to the present invention are described.

The process cartridge according to the present invention is characterized by integrally supporting the electrophotographic photosensitive member described above, and at least one unit selected from the group consisting of: a charging unit; a developing unit; and a cleaning unit, and being detachably attachable onto a main body of an electrophotographic apparatus.

In addition, the electrophotographic apparatus according to the present invention is characterized by including the electrophotographic photosensitive member described above, and a charging unit, an exposing unit, a developing unit, and a transfer unit.

The charging unit can be a charging unit configured to positively charge the electrophotographic photosensitive member.

### [Electrophotographic Apparatus]

An example of a configuration of the electrophotographic apparatus according to the present invention is described below in detail.

A tandem-type color electrophotographic apparatus is described below as an example with reference to FIG. 4. FIG. 4 is a sectional view for illustrating an example of a configuration of an electrophotographic apparatus. An electrophotographic apparatus 100 illustrated in FIG. 4 includes image forming units 40a, 40b, 40c, and 40d, a transfer belt 50, and a fixing device 54. When distinction is not required, each of the image forming units 40a, 40b, 40c, and 40d is hereinafter referred to as “image forming unit 40.” The image forming unit 40 includes an image bearing member 30, a charging device 42, an exposing device 44, a developing device 46, and a transfer device 48. The image bearing member 30 is a photosensitive member (specifically, the monolayer type photosensitive member 1). In addition, a recording medium P is located in a lower portion of the electrophotographic apparatus. The image bearing member 30 is arranged at the center position of the imaging forming unit 40. The image bearing member 30 is arranged so as to be rotatable in the arrow direction (counterclockwise direction in FIG. 4). The charging device 42, the exposing device 44, the developing device 46, and the transfer device 48 are arranged on the periphery of the image bearing member 30 in the stated order from an upstream side in the rotation direction of the image bearing member 30.

Toner images of a plurality of colors (e.g., four colors of black, cyan, magenta, and yellow) are successively superimposed on the recording medium P on the transfer belt 50 by each of the image forming units 40a to 40d.

The charging device 42 charges the surface (e.g., a peripheral surface) of the image bearing member 30 with positive polarity. When the image bearing member 30 is the monolayer type photosensitive member 1, the surface of the image bearing member 30 is charged with positive polarity. The charging device 42 is, for example, a charging roller.

The exposing device 44 irradiates the charged surface of the image bearing member 30 with exposure light. That is, the exposing device 44 exposes the charged surface of the image bearing member 30 to light. As a result, an electrostatic latent image is formed on the surface of the image bearing member 30. The electrostatic latent image is formed based on image data input to the electrophotographic apparatus 100.

The developing device 46 supplies toner to the surface of the image bearing member 30, to thereby develop the electrostatic latent image as a toner image. The developing device 46 (e.g., the surface of the developing device 46, more specifically, the peripheral surface of the developing device 46) is in contact with the surface of the image bearing member 30. That is, the electrophotographic apparatus 100 adopts a contact developing system. The developing device 46 is, for example, a developing roller. When a developer is a one-component developer, the developing device 46 supplies toner that is a one-component developer to the electrostatic latent image formed on the image bearing member 30. When the developer is a two-component developer, the developing device 46 supplies toner among the toner and a carrier in the two-component developer to the electrostatic latent image formed on the image bearing member 30. In this manner, the image bearing member 30 bears the toner image.

The transfer belt 50 conveys the recording medium P to the position between the image bearing member 30 and the transfer device 48. The transfer belt 50 is an endless belt. The transfer belt 50 is arranged so as to be rotatable in the arrow direction (clockwise direction in FIG. 4). The transfer device 48 transfers the toner image developed by the developing device 46 from the surface of the image bearing member 30 to a transfer target member. The transfer target member is the recording medium P. When the toner image is transferred, the image bearing member 30 is in contact with the recording medium P. That is, the electrophotographic apparatus 100 adopts a direct transfer system. The transfer device 48 is, for example, a transfer roller. The recording medium P having the toner image transferred thereto by the transfer device 48 is conveyed to the fixing device 54 by the transfer belt 50.

The fixing device 54 is, for example, a heating roller and/or a pressure roller. The unfixed toner image having been transferred by the transfer device 48 is heated and/or pressurized by the fixing device 54. The toner image is fixed to the recording medium P by being heated and/or pressurized. As a result, an image is formed on the recording medium P.

An example of the electrophotographic apparatus has been described above, but the electrophotographic apparatus is not limited to the electrophotographic apparatus 100 described above. The electrophotographic apparatus 100 described above is a color electrophotographic apparatus, but the electrophotographic apparatus may also be a monochrome electrophotographic apparatus. In this case, it is only required that the electrophotographic apparatus include, for example, only one image forming unit.

In addition, the electrophotographic apparatus 100 described above adopts a tandem system, but the electrophotographic apparatus may also adopt, for example, a rotary system.

The charging device 42 has been described by taking the charging roller as an example, but the charging device may be a charging device other than the charging roller (e.g., a scorotron charger, a charging brush, or a corotron charger). The electrophotographic apparatus 100 described above adopts a contact developing system, but the electrophotographic apparatus may also adopt a non-contact developing system.

The electrophotographic apparatus 100 described above adopts a direct transfer system, but the electrophotographic apparatus may also adopt an intermediate transfer system. When the electrophotographic apparatus adopts an intermediate transfer system, the transfer target member corresponds to an intermediate transfer belt. In the electrophotographic apparatus, the image forming unit 40 described above does not include a cleaning member, but the image forming unit may further include a cleaning member (e.g., a cleaning blade).

The image forming unit 40 described above does not include a charge eliminating device, but the image forming unit may further include a charge eliminating device.

### [Process Cartridge]

Next, with continued reference to FIG. 4, an example of a configuration of a process cartridge according to the present invention is described. The process cartridge is included in each of the image forming units 40a to 40d. The process cartridge includes the image bearing member 30. The image bearing member 30 is a photosensitive member (specifically, the monolayer type photosensitive member 1). The process cartridge further includes, in addition to the image bearing member 30, at least one selected from the group consisting of: the charging device 42; the developing device 46; and the cleaning member (not shown).

The process cartridge is designed so as to be detachably attachable onto the electrophotographic apparatus 100. Thus, the process cartridge is easy to handle and can be easily and quickly replaced together with the image bearing member 30 when the sensitivity characteristic and the like of the image bearing member 30 deteriorate. The process cartridge including the photosensitive member has been described above with reference to FIG. 4.

According to the present invention, there can be provided an electrophotographic photosensitive member, which has high durability, and in which a decrease in sensitivity at the time of repeated use is suppressed.

### EXAMPLES

The present invention is described below in more detail by way of Examples and Comparative Examples. The present invention is by no means limited by the following Examples within a scope not departing from the gist of the present invention. In the following description of Examples, the term “part(s)” is by mass unless otherwise specified.

### <Production of Polyarylate Resin (PAR)>

### [Synthesis of Resin (PAR-1)]

A three-necked flask including a temperature gauge, a three-way cock, and a dropping funnel was used as a reaction vessel.

First, the following materials were prepared.
Compound (BP-2) (28.7 mmol) serving as a monomer
Compound (BP-1) (12.3 mmol) serving as a monomer
2,6-Dimethylphenol (DMP) (0.413 mmol) serving as an end terminator
Sodium hydroxide (98 mmol)
Benzyltributylammonium chloride (0.384 mmol)

The above-mentioned materials were loaded into the reaction vessel, and air in the reaction vessel was replaced by an argon gas. Water (300 mL) was added to the contents of the reaction vessel. The contents of the reaction vessel were stirred at 50° C. for 1 hour. The contents of the reaction vessel were cooled to 10° C. to provide an alkaline aqueous solution A.

Next, a dicarboxylic acid dichloride (20.8 mmol) of the compound (DC-1) serving as a monomer, and a dicarboxylic acid dichloride (11.2 mmol) of the compound (DC-2) serving as a monomer were dissolved in chloroform (150 mL). As a result, a chloroform solution B was obtained.

The chloroform solution B was slowly dropped into the alkaline aqueous solution A over 110 minutes through use of the dropping funnel. The contents of the reaction vessel were stirred for 4 hours to allow a polymerization reaction to proceed while the temperature (liquid temperature) of the contents of the reaction vessel was regulated to 15±5° C. The upper layer (aqueous layer) of the contents of the reaction vessel was removed by decantation. Thus, an organic layer was obtained. Next, ion-exchanged water (400 mL) was loaded into an Erlenmeyer flask. The resultant organic layer was further added to the Erlenmeyer flask. Chloroform (400 mL) and acetic acid (2 mL) were further added to the Erlenmeyer flask. The contents of the Erlenmeyer flask were stirred at room temperature (25° C.) for 30 minutes. The upper layer (aqueous layer) of the contents of the Erlenmeyer flask was removed by decantation. Thus, an organic layer was obtained. The resultant organic layer was washed with ion-exchanged water (1 L) through use of a separating funnel. The washing with ion-exchanged water was repeated five times. Thus, a water-washed organic layer was obtained. Next, the water-washed organic layer was filtered to provide filtrate. The resultant filtrate was slowly dropped into methanol (1 L) to provide a precipitate. The precipitate was taken out by filtration. The precipitate thus taken out was dried in a vacuum at a temperature of 70° C. for 12 hours. As a result, a resin (PAR-1) having a viscosity-average molecular weight of 55,000 was obtained.

### [Synthesis of Resins (PAR-2) to (PAR-16) and (PAR-R1) to (PAR-R4)]

Resins (PAR-2) to (PAR-16) and (PAR-R1) to (PAR-R4) were each synthesized by the same method as that in the synthesis of the resin (PAR-1) except that the molar ratios of the bisphenol and the dicarboxylic acid, and the kind of the end terminator were changed as shown in Table 2. As a result, the resins (PAR-2) to (PAR-16) and (PAR-R1) to (PAR-R4) having viscosity-average molecular weights shown in Table 2 were obtained. The viscosity-average molecular weight of each of the resins (PARs) was adjusted by changing the usage amount of the end terminator, and the usage amount of the end terminator was reduced when the viscosity-average molecular weight of each of the resins (PARs) was increased.

TABLE 2

| | Bisphenol | | Dicarboxylic acid | | End | Molecular |
|---|---|---|---|---|---|---|
| Resin | BP-1 | BP-2 | DC-1 | DC-2 | terminator | weight |
| PAR-1 | 70 | 30 | 65 | 35 | DMP | 55,000 |
| PAR-2 | 70 | 30 | 50 | 50 | DMP | 53,000 |
| PAR-3 | 70 | 30 | 55 | 45 | DMP | 66,000 |
| PAR-4 | 50 | 50 | 80 | 20 | DMP | 79,000 |
| PAR-5 | 50 | 50 | 40 | 60 | DMP | 61,000 |
| PAR-6 | 50 | 50 | 20 | 80 | DMP | 44,000 |
| PAR-7 | 20 | 80 | 65 | 35 | DMP | 56,000 |
| PAR-8 | 20 | 80 | 55 | 45 | DMP | 51,000 |
| PAR-9 | 20 | 80 | 50 | 50 | DMP | 67,000 |
| PAR-10 | 20 | 80 | 65 | 35 | PFH | 53,000 |
| PAR-11 | 10 | 90 | 65 | 35 | DMP | 60,000 |
| PAR-12 | 10 | 90 | 50 | 50 | DMP | 62,000 |
| PAR-13 | 35 | 65 | 30 | 70 | DMP | 61,000 |
| PAR-14 | 50 | 50 | 70 | 30 | DMP | 64,000 |
| PAR-15 | 35 | 65 | 90 | 10 | DMP | 76,000 |
| PAR-16 | 35 | 65 | 75 | 25 | DMP | 72,000 |
| PAR-R1 | 100 | — | 100 | — | DMP | 35,000 |
| PAR-R2 | — | 100 | — | 100 | DMP | 68,000 |
| PAR-R3 | 50 | 50 | — | 100 | DMP | 60,000 |
| PAR-R4 | — | 100 | 50 | 50 | DMP | 55,000 |

The numerical values regarding the bisphenols shown in Table 2 each indicate a molar ratio (percentage) with respect to the total substance amount of the compound (BP-1) and the compound (BP-2). In addition, the numerical values regarding the dicarboxylic acids shown in Table 2 each indicate a molar ratio (percentage) with respect to the total substance amount of the compound (DC-1) and the compound (DC-2). In addition, “PFH” represents 1H,1H-perfluoro-1-heptanol. In addition, the molecular weight indicates a viscosity-average molecular weight.

### Example 1

### <Production of Electrophotographic Photosensitive Member>

### [Production of Photosensitive Member 1]

An aluminum cylinder (JIS-A3003, aluminum alloy) having a length of 260.5 mm and a diameter of 30 mm was subjected to cutting processing (JIS B0601:2014, ten-point average roughness Rzjis: 0.8 μm), and the resultant was used as an electroconductive support.

The following materials were prepared.
Y-form titanyl phthalocyanine (CGM-1) serving as a charge generating material 10.0 parts by mass
Hole transporting material (H-1) 70.0 parts by mass
Electron transporting material (E-4) 35.0 parts by mass
Polyarylate resin (PAR-1) serving as a binder resin 100.0 parts by mass
Additive (T-1) 1.6 parts by mass
Tetrahydrofuran serving as a solvent 500.0 parts by mass

The above-mentioned materials were mixed with a rod-shaped sonic oscillator for 20 minutes to provide a dispersion liquid. The dispersion liquid was filtered through a filter having an opening of 5 μm to provide a coating liquid for a photosensitive layer. The coating liquid for a photosensitive layer was applied onto the electroconductive support by a dip coating method, and was dried with hot air at 120° C. for 50 minutes. Thus, a photosensitive layer (thickness: 30 μm) was formed on the electroconductive support to provide a photosensitive member 1.

### (Resin Component Analysis of Photosensitive Member 1)

A ¹H-NMR spectrum was obtained by ¹H-nuclear magnetic resonance spectrometry of polymer components recovered from the resultant photosensitive member in deuterated chloroform. The resultant ¹H-NMR spectrum had peaks at 8.22±0.02 ppm, 7.18±0.02 ppm, 7.16±0.02 ppm, 7.10±0.02 ppm, 7.06±0.02 ppm, 7.04±0.02 ppm, 2.28±0.02 ppm, 2.20±0.02 ppm, 1.59±0.02 ppm, and 1.54±0.02 ppm. As a result, it was identified that the photosensitive member had the structural units represented by the formulae (1), (2), (3), and (4). In addition, it was able to be recognized that the ratios of the substance amounts of the structural units represented by the formula (1), the formula (2), the formula (3), and the formula (4) were as shown in Table 2 based on the integration ratios of the above-mentioned peaks.

### <Evaluation>

The photosensitive member (monolayer type photosensitive member) was evaluated for sensitivity, image smearing, and wear resistance by the following methods.

A modified apparatus of “ECOSYS P5026cdw” manufactured by KYOCERA Document Solutions Japan Inc. was used as an electrophotographic apparatus. The modified apparatus included a charging roller as a charging device. The charging polarity of the charging roller was positive polarity, and the applied voltage of the charging roller was a DC voltage. In addition, this evaluation machine included a cleaning blade and a charge eliminating device. An electrophotographic photosensitive member of a drum unit in a cartridge for this printer was removed, and the photosensitive member 1 was set instead.

### [Evaluation of Sensitivity]

The surface potential of the photosensitive member having the surface charged and then irradiated with exposure light was evaluated as sensitivity (V). Specifically, the sensitivity was evaluated as described below.

First, the electrophotographic apparatus and the photosensitive member were left under an environment at a temperature of 23° C. and a humidity of 50% RH for 24 hours or more, and then a potential measurement device for the surface of the photosensitive member was mounted on the electrophotographic apparatus.

The applied voltage was adjusted so that the surface of the photosensitive member reached a predetermined potential (Vd: +700 V). Next, the surface of the photosensitive member was charged, and then the surface of the photosensitive member was exposed to light at an exposure amount of 0.25 μJ/cm². The surface potential at this time was used as initial sensitivity. A smaller value indicates better sensitivity. Next, a solid image was output onto 10,000 sheets, and the surface potential was measured in the same manner and used as sensitivity after endurance. The evaluation results are shown in Table 3 (Tables 3-1 to 3-4).

### [Evaluation of Image Smearing]

First, the electrophotographic apparatus and the photosensitive member were left under an environment at a temperature of 30° C. and a humidity of 80% RH for 24 hours or more, and then the photosensitive member was mounted on the electrophotographic apparatus.

Subsequently, an image having an image print ratio of 3% was output onto 30,000 sheets of A4 portrait size paper. After that, the power supply to the evaluation device was stopped and deactivated for 3 days. After the deactivation for 3 days, the power supply to the evaluation device was started again, and a character image (E character image) in which a lattice image and the alphabetical character E (font type: Times, font size: 6 points) were repeated was output onto A4 portrait size paper. The resultant images were each evaluated for an image defect suppressing effect in accordance with the following evaluation ranks. The higher rank number indicates a more satisfactory effect, and the ranks 5, 4, and 3 were determined to be the levels at which the image defect suppressing effect was obtained. Meanwhile, the ranks 1 and 2 were determined to be the levels at which the image defect suppressing effect was not obtained. The evaluation results are shown in Table 3.
Rank 5: No image defect is observed in both the lattice image and the E character image.
Rank 4: The lattice image is partially blurred, but no image defect is observed in the E character image.
Rank 3: The lattice image is partially blurred, and the E character image is partially faded.
Rank 2: The lattice image is partially lost, and the E character image is entirely faded.
Rank 1: The lattice image is entirely lost, and the E character image is entirely faded.

### [Evaluation of Wear Resistance]

The thickness on the surface of a center portion of the photosensitive member 1 used in the evaluation of image smearing was measured for a decrease amount (abrasion amount) from an initial stage. In this case, the thickness was measured with a thickness measurement device FISCHER MMS eddy current probe EAW3.3 manufactured by FISCHER INSTRUMENTS K.K. The decrease amount of the thickness of the photosensitive layer was evaluated based on a value obtained by converting the decrease amount after the output of an image onto 30,000 sheets into the decrease amount per 1,000 sheets. The evaluation results are shown in Table 3.

### Examples 2 to 42 and Comparative Examples 1 to 9

Electrophotographic photosensitive members were each produced and evaluated in the same manner as in Example 1 except that the kinds and amounts of the binder resin, the hole transporting material, the electron transporting material, the charge generating material, and the additive to be mixed with the coating liquid for a photosensitive layer were changed as shown in Table 4. The results are shown in Table 3.

The hole transporting material HR-1 shown in Table 3 is a compound represented by the following formula (HR-1).

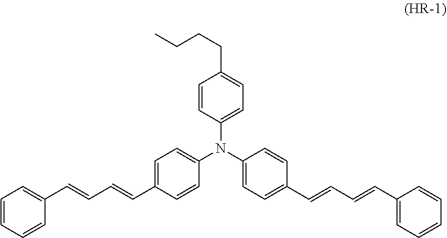 [SMILES: CCCCc1ccc(N(c2ccc(/C=C/C=C/c3ccccc3)cc2)c2ccc(/C=C/C=C/c3ccccc3)cc2)cc1]

In addition, the hole transporting material HR-2 shown in Table 3 is a compound represented by the following formula (HR-2).

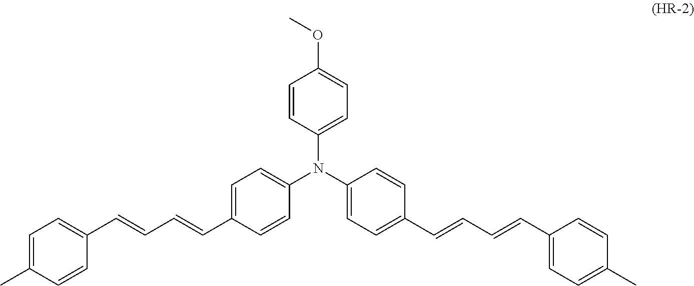

In addition, the hole transporting material HR-3 shown in Table 3 is a compound represented by the following formula (HR-3).

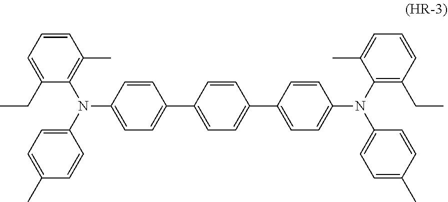 [SMILES: CCc1cccc(C)c1N(c1ccc(C)cc1)c1ccc(-c2ccc(-c3ccc(N(c4ccc(C)cc4)c4c(C)cccc4CC)cc3)cc2)cc1]

In addition, the hole transporting material HR-4 shown in Table 3 is a compound represented by the following formula (HR-4).

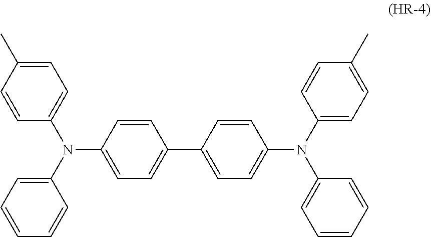 [SMILES: Cc1ccc(N(c2ccccc2)c2ccc(-c3ccc(N(c4ccccc4)c4ccc(C)cc4)cc3)cc2)cc1]

In addition, the hole transporting material HR-5 shown in Table 3 is a compound represented by the following formula (HR-5).

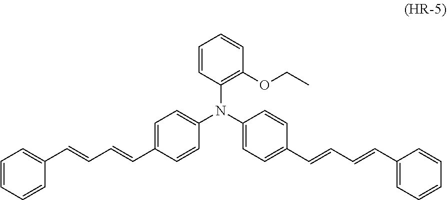 [SMILES: CCOc1ccccc1N(c1ccc(/C=C/C=C/c2ccccc2)cc1)c1ccc(/C=C/C=C/c2ccccc2)cc1]

TABLE 3-1

| | | | | | | Electron transporting | |
|---|---|---|---|---|---|---|---|
| | | Polyarylate resin | | Hole transporting material | | material | |
| | | | Parts by | | Parts by | | Parts by |
| | Photosensitive member | Kind | mass | Kind | mass | Kind | mass |
| Example 1 | Photosensitive member 1 | PAR-1 | 100 | H-1 | 70 | E-4 | 35 |
| Example 2 | Photosensitive member 2 | PAR-2 | 100 | H-1 | 70 | E-4 | 35 |
| Example 3 | Photosensitive member 3 | PAR-3 | 100 | H-1 | 70 | E-4 | 35 |
| Example 4 | Photosensitive member 4 | PAR-4 | 100 | H-1 | 70 | E-4 | 35 |
| Example 5 | Photosensitive member 5 | PAR-5 | 100 | H-1 | 70 | E-4 | 35 |
| Example 6 | Photosensitive member 6 | PAR-6 | 100 | H-1 | 70 | E-4 | 35 |
| Example 7 | Photosensitive member 7 | PAR-7 | 100 | H-1 | 70 | E-4 | 35 |
| Example 8 | Photosensitive member 8 | PAR-8 | 100 | H-1 | 70 | E-4 | 35 |
| Example 9 | Photosensitive member 9 | PAR-9 | 100 | H-1 | 70 | E-4 | 35 |
| Example 10 | Photosensitive member 10 | PAR-10 | 100 | H-1 | 70 | E-4 | 35 |
| Example 11 | Photosensitive member 11 | PAR-11 | 100 | H-1 | 70 | E-4 | 35 |
| Example 12 | Photosensitive member 12 | PAR-12 | 100 | H-1 | 70 | E-4 | 35 |
| Example 13 | Photosensitive member 13 | PAR-7 | 70 | H-1 | 70 | E-4 | 35 |
| Example 14 | Photosensitive member 14 | PAR-7 | 120 | H-1 | 70 | E-4 | 35 |
| Example 15 | Photosensitive member 15 | PAR-7 | 100 | H-1 | 55 | E-4 | 50 |
| Example 16 | Photosensitive member 16 | PAR-7 | 100 | H-1 | 80 | E-4 | 25 |
| Example 17 | Photosensitive member 17 | PAR-7 | 100 | H-2 | 70 | E-4 | 35 |
| Example 18 | Photosensitive member 18 | PAR-7 | 100 | H-3 | 70 | E-4 | 35 |
| Example 19 | Photosensitive member 19 | PAR-7 | 100 | H-4 | 70 | E-4 | 35 |
| Example 20 | Photosensitive member 20 | PAR-7 | 100 | H-6 | 70 | E-4 | 35 |
| Example 21 | Photosensitive member 21 | PAR-7 | 100 | H-8 | 70 | E-4 | 35 |
| Example 22 | Photosensitive member 22 | PAR-7 | 100 | H-9 | 70 | E-4 | 35 |
| Example 23 | Photosensitive member 23 | PAR-7 | 100 | H-1 | 70 | E-1 | 35 |
| Example 24 | Photosensitive member 24 | PAR-7 | 100 | H-1 | 70 | E-2 | 35 |
| Example 25 | Photosensitive member 25 | PAR-7 | 100 | H-1 | 70 | E-3 | 35 |
| Example 26 | Photosensitive member 26 | PAR-7 | 100 | H-1 | 70 | E-5 | 35 |
| Example 27 | Photosensitive member 27 | PAR-7 | 100 | H-1 | 70 | E-6 | 35 |
| Example 28 | Photosensitive member 28 | PAR-7 | 100 | H-1 | 70 | E-7 | 35 |
| Example 29 | Photosensitive member 29 | PAR-7 | 100 | H-1 | 70 | E-8 | 35 |
| Example 30 | Photosensitive member 30 | PAR-7 | 100 | H-1 | 70 | E-4 | 35 |
| Example 31 | Photosensitive member 31 | PAR-7 | 100 | H-1 | 70 | E-4 | 35 |
| Example 32 | Photosensitive member 32 | PAR-7 | 100 | H-1 | 70 | E-4 | 35 |
| Example 33 | Photosensitive member 33 | PAR-7 | 100 | H-1 | 70 | E-4 | 35 |
| Example 34 | Photosensitive member 34 | PAR-13 | 100 | H-1 | 70 | E-4 | 35 |
| Example 35 | Photosensitive member 35 | PAR-14 | 100 | H-1 | 70 | E-4 | 35 |
| Example 36 | Photosensitive member 36 | PAR-15 | 100 | H-1 | 70 | E-4 | 35 |
| Example 37 | Photosensitive member 37 | PAR-16 | 100 | H-1 | 70 | E-4 | 35 |
| Example 38 | Photosensitive member 38 | PAR-7/ | 60/40 | H-1 | 70 | E-4 | 35 |
| | | PAR-R3 | | | | | |
| Example 39 | Photosensitive member 39 | PAR-7/ | 50/50 | H-1 | 70 | E-4 | 35 |
| | | PAR-R3 | | | | | |
| Example 40 | Photosensitive member 40 | PAR-7/ | 40/60 | H-1 | 70 | E-4 | 35 |
| | | PAR-R3 | | | | | |
| Example 41 | Photosensitive member 41 | PAR-7 | 100 | H-1/ | 35/35 | E-4 | 35 |
| | | | | HR-3 | | | |
| Example 42 | Photosensitive member 42 | PAR-7 | 100 | H-1/ | 42/28 | E-4 | 35 |
| | | | | HR-3 | | | |
| Comparative | Photosensitive member R1 | PAR-R1 | 100 | H-1 | 70 | E-4 | 35 |
| Example 1 | | | | | | | |
| Comparative | Photosensitive member R2 | PAR-R2 | 100 | H-1 | 70 | E-4 | 35 |
| Example 2 | | | | | | | |
| Comparative | Photosensitive member R3 | PAR-R3 | 100 | H-1 | 70 | E-4 | 35 |
| Example 3 | | | | | | | |
| Comparative | Photosensitive member R4 | PAR-R4 | 100 | H-1 | 70 | E-4 | 35 |
| Example 4 | | | | | | | |
| Comparative | Photosensitive member R5 | PAR-1 | 100 | HR- | 70 | E-4 | 35 |
| Example 5 | | | | | | | |
| Comparative | Photosensitive member R6 | PAR-1 | 100 | HR-2 | 70 | E-4 | 35 |
| Example 6 | | | | | | | |
| Comparative | Photosensitive member R7 | PAR-1 | 100 | HR-3 | 70 | E-4 | 35 |
| Example 7 | | | | | | | |
| Comparative | Photosensitive member R8 | PAR-1 | 100 | HR-4 | 70 | E-4 | 35 |
| Example 8 | | | | | | | |
| Comparative | Photosensitive member R8 | PAR-1 | 100 | HR-5 | 70 | E-4 | 35 |
| Example 9 | | | | | | | |

| | Charge generating | | | | | | | |
|---|---|---|---|---|---|---|---|---|
| | material | | Additive | | Sensitivity (V) | | Evaluation | |
| | | Parts by | | Parts by | | After | of image | amount |
| | Kind | mass | Kind | mass | Initial | endurance | smearing | (μm) |
| Example 1 | CGM-1 | 10 | T-1 | 1.6 | 255 | 262 | 5 | 1.5 |
| Example 2 | CGM-1 | 10 | T-1 | 1.6 | 253 | 261 | 5 | 1.7 |
| Example 3 | CGM-1 | 10 | T-1 | 1.6 | 252 | 264 | 5 | 1.7 |
| Example 4 | CGM-1 | 10 | T-1 | 1.6 | 254 | 261 | 5 | 1.8 |
| Example 5 | CGM-1 | 10 | T-1 | 1.6 | 258 | 262 | 5 | 1.6 |
| Example 6 | CGM-1 | 10 | T-1 | 1.6 | 256 | 264 | 5 | 1.5 |
| Example 7 | CGM-1 | 10 | T-1 | 1.6 | 241 | 247 | 5 | 1.1 |
| Example 8 | CGM-1 | 10 | T-1 | 1.6 | 247 | 251 | 5 | 1.3 |
| Example 9 | CGM-1 | 10 | T-1 | 1.6 | 245 | 249 | 5 | 1.5 |
| Example 10 | CGM-1 | 10 | T-1 | 1.6 | 243 | 248 | 5 | 1.2 |
| Example 11 | CGM-1 | 10 | T-1 | 1.6 | 255 | 266 | 5 | 1.6 |
| Example 12 | CGM-1 | 10 | T-1 | 1.6 | 256 | 263 | 5 | 1.7 |
| Example 13 | CGM-1 | 10 | T-1 | 1.6 | 242 | 244 | 5 | 1.3 |
| Example 14 | CGM-1 | 10 | T-1 | 1.6 | 251 | 254 | 5 | 1.2 |
| Example 15 | CGM-1 | 10 | T-1 | 1.6 | 247 | 251 | 5 | 1.3 |
| Example 16 | CGM-1 | 10 | T-1 | 1.6 | 243 | 246 | 5 | 1.2 |
| Example 17 | CGM-1 | 10 | T-1 | 1.6 | 248 | 253 | 5 | 1.2 |
| Example 18 | CGM-1 | 10 | T-1 | 1.6 | 247 | 250 | 5 | 1.3 |
| Example 19 | CGM-1 | 10 | T-1 | 1.6 | 251 | 255 | 5 | 1.4 |
| Example 20 | CGM-1 | 10 | T-1 | 1.6 | 255 | 261 | 5 | 1.7 |
| Example 21 | CGM-1 | 10 | T-1 | 1.6 | 264 | 270 | 5 | 1.8 |
| Example 22 | CGM-1 | 10 | T-1 | 1.6 | 266 | 272 | 5 | 1.8 |
| Example 23 | CGM-1 | 10 | T-1 | 1.6 | 261 | 266 | 5 | 1.5 |
| Example 24 | CGM-1 | 10 | T-1 | 1.6 | 263 | 267 | 5 | 1.5 |
| Example 25 | CGM-1 | 10 | T-1 | 1.6 | 265 | 270 | 5 | 1.7 |
| Example 26 | CGM-1 | 10 | T-1 | 1.6 | 266 | 269 | 5 | 1.6 |
| Example 27 | CGM-1 | 10 | T-1 | 1.6 | 263 | 269 | 5 | 1.6 |
| Example 28 | CGM-1 | 10 | T-1 | 1.6 | 261 | 268 | 5 | 1.5 |
| Example 29 | CGM-1 | 10 | T-1 | 1.6 | 267 | 271 | 5 | 1.8 |
| Example 30 | CGM-1 | 10 | T-2 | 1.6 | 244 | 248 | 5 | 1.3 |
| Example 31 | CGM-1 | 10 | T-3 | 1.6 | 247 | 251 | 5 | 1.3 |
| Example 32 | CGM-1 | 10 | T-4 | 1.6 | 243 | 246 | 5 | 1.2 |
| Example 33 | CGM-1 | 10 | None | 0 | 241 | 255 | 5 | 1.4 |
| Example 34 | CGM-1 | 10 | T-1 | 1.6 | 271 | 277 | 5 | 1.7 |
| Example 35 | CGM-1 | 10 | T-1 | 1.6 | 257 | 260 | 5 | 1.1 |
| Example 36 | CGM-1 | 10 | T-1 | 1.6 | 266 | 276 | 5 | 1.4 |
| Example 37 | CGM-1 | 10 | T-1 | 1.6 | 275 | 279 | 5 | 1.6 |
| Example 38 | CGM-1 | 10 | T-1 | 1.6 | 278 | 283 | 5 | 1.3 |
| Example 39 | CGM-1 | 10 | T-1 | 1.6 | 273 | 288 | 5 | 1.2 |
| Example 40 | CGM-1 | 10 | T-1 | 1.6 | 268 | 286 | 5 | 1.6 |
| Example 41 | CGM-1 | 2 | T-1 | 1.6 | 276 | 287 | 5 | 1.5 |
| Example 42 | CGM-1 | 2 | T-1 | 1.6 | 269 | 281 | 5 | 1.2 |
| Comparative | CGM-1 | 10 | T-1 | 1.6 | 283 | 315 | 1 | 1.8 |
| Example 1 | | | | | | | | |
| Comparative | CGM-1 | 10 | T-1 | 1.6 | 286 | 311 | 5 | 2.8 |
| Example 2 | | | | | | | | |
| Comparative | CGM-1 | 10 | T-1 | 1.6 | 291 | 316 | 3 | 2.3 |
| Example 3 | | | | | | | | |
| Comparative | CGM-1 | 10 | T-1 | 1.6 | 296 | 320 | 1 | 2.0 |
| Example 4 | | | | | | | | |
| Comparative | CGM-1 | 10 | T-1 | 1.6 | 304 | 317 | 2 | 2.1 |
| Example 5 | | | | | | | | |
| Comparative | CGM-1 | 10 | T-1 | 1.6 | 308 | 318 | 2 | 2.3 |
| Example 6 | | | | | | | | |
| Comparative | CGM-1 | 10 | T-1 | 1.6 | 306 | 311 | 2 | 2.0 |
| Example 7 | | | | | | | | |
| Comparative | CGM-1 | 10 | T-1 | 1.6 | 307 | 315 | 2 | 1.9 |
| Example 8 | | | | | | | | |
| Comparative | CGM-1 | 10 | T-1 | 1.6 | 301 | 310 | 2 | 2.4 |
| Example 9 | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-195285, filed Nov. 16, 2023, and Japanese Patent Application No. 2024-173828, filed Oct. 2, 2024, which are hereby incorporated by reference herein in their entirety.

1. An electrophotographic photosensitive member comprising:
a support; and
a photosensitive layer,
wherein the photosensitive layer contains a binder resin, a charge generating material, an electron transporting material, and a hole transporting material,
wherein the binder resin contains a polyarylate resin having a structural unit represented by the following formula (1), a structural unit represented by the following formula (2), a structural unit represented by the following formula (3), and a structural unit represented by the following formula (4): 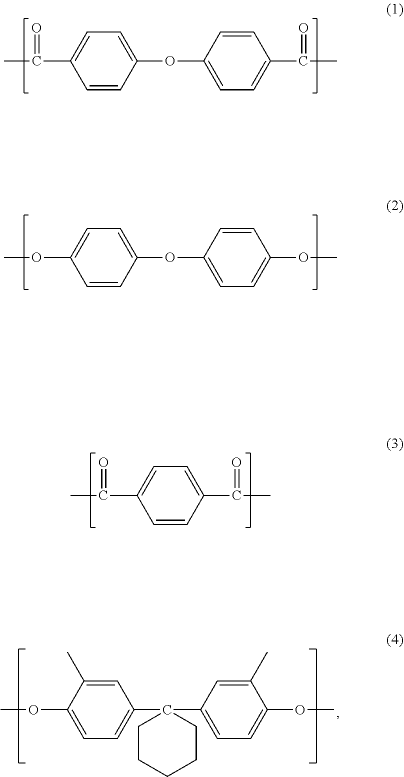
and
wherein the hole transporting material contains a compound represented by the following formula (5): 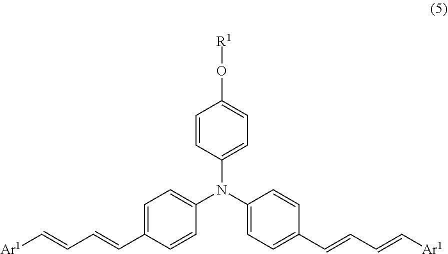
in the formula (5), R¹ represents an alkyl group having 2 or more and 4 or less carbon atoms, and Ar¹ represents an aryl group that may have an alkyl group having 1 or more and 4 or less carbon atoms as a substituent.

2. The electrophotographic photosensitive member according to claim 1, wherein a ratio of a substance amount in terms of mole of the structural unit represented by the formula (1) is 0.30 or more with respect to a total substance amount in terms of mole of structural units derived from dicarboxylic acids for forming the polyarylate resin.

3. The electrophotographic photosensitive member according to claim 1, wherein, in the polyarylate resin, when a ratio of a substance amount in terms of mole of the structural unit represented by the formula (1) to a total substance amount in terms of mole of the structural units for forming the polyarylate resin is represented by M1, a ratio of a substance amount in terms of mole of the structural unit represented by the formula (2) to the total substance amount in terms of mole of the structural units for forming the polyarylate resin is represented by M2, a ratio of a substance amount in terms of mole of the structural unit represented by the formula (3) to the total substance amount in terms of mole of the structural units for forming the polyarylate resin is represented by M3, and a ratio of a substance amount in terms of mole of the structural unit represented by the formula (4) to the total substance amount in terms of mole of the structural units for forming the polyarylate resin is represented by M4, M3/(M1+M3) is 0.30 or more and less than 0.70, and M2/(M2+M4) is 0.10 or more and less than 0.50.

4. The electrophotographic photosensitive member according to claim 1, wherein a ratio of the polyarylate resin is 50 mass % or more with respect to a total mass of the binder resin.

5. The electrophotographic photosensitive member according to claim 1, wherein a content of the hole transporting material is 50 parts by mass or more and 90 parts by mass or less with respect to 100 parts by mass of the binder resin.

6. The electrophotographic photosensitive member according to claim 1, wherein a ratio of a substance amount in terms of mole of the compound represented by the formula (5) is 0.6 or more with respect to a total substance amount in terms of mole of the hole transporting material.

7. The electrophotographic photosensitive member according to claim 1, wherein, in the formula (5), Ar¹ represents a phenyl group that may have an alkyl group having 1 or more and 4 or less carbon atoms as a substituent.

8. The electrophotographic photosensitive member according to claim 1, wherein the charge generating material contains titanyl phthalocyanine.

9. The electrophotographic photosensitive member according to claim 1, wherein the electron transporting material contains at least one compound selected from the group consisting of: a compound represented by the following formula (6); a compound represented by the following formula (7); a compound represented by the following formula (8); a compound represented by the following formula (9); a compound represented by the following formula (10); a compound represented by the following formula (11); and a compound represented by the following formula (12): 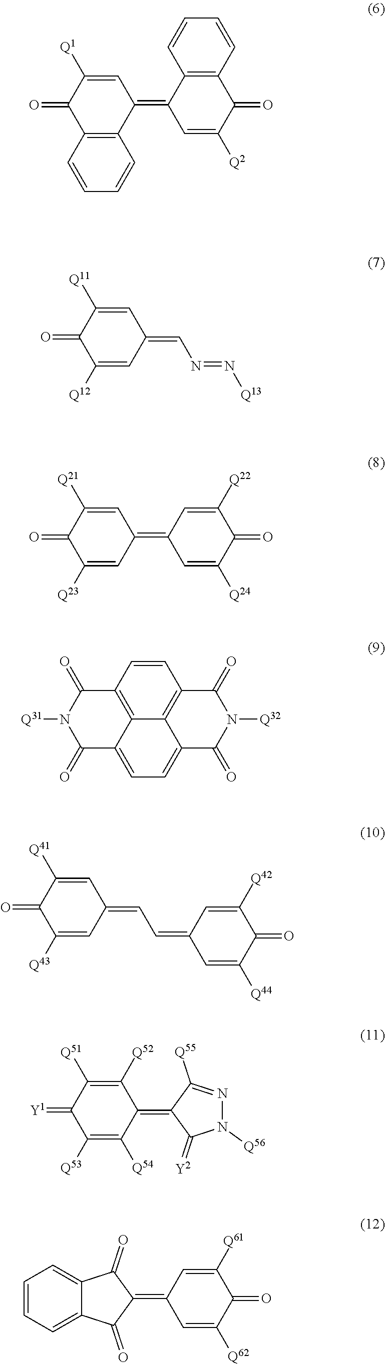
where Q¹ and Q² in the formula (6), Q¹¹, Q¹², and Q¹³ in the formula (7), Q²¹, Q²², Q²³, and Q²⁴ in the formula (8), Q³¹ and Q³² in the formula (9), Q⁴¹, Q⁴², Q⁴³, and Q⁴⁴ in the formula (10), Q⁵¹, Q⁵², Q⁵³, Q⁵⁴, Q⁵⁵, and Q⁵⁶ in the formula (11), and Q⁶¹ and Q⁶² in the formula (12) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group having 6 or more and 14 or less carbon atoms that may be substituted with at least one substituent selected from the group consisting of: an alkyl group having 1 or more and 6 or less carbon atoms; and a halogen atom, and Y¹ and Y² in the formula (11) each independently represent an oxygen atom or a sulfur atom.

10. The electrophotographic photosensitive member according to claim 9, wherein the electron transporting material contains at least one compound selected from the group consisting of: a compound represented by the following formula (E-1); a compound represented by the following formula (E-2); a compound represented by the following formula (E-3); a compound represented by the following formula (E-4); a compound represented by the following formula (E-5); a compound represented by the following formula (E-6); a compound represented by the following formula (E-7); and a compound represented by the following formula (E-8).

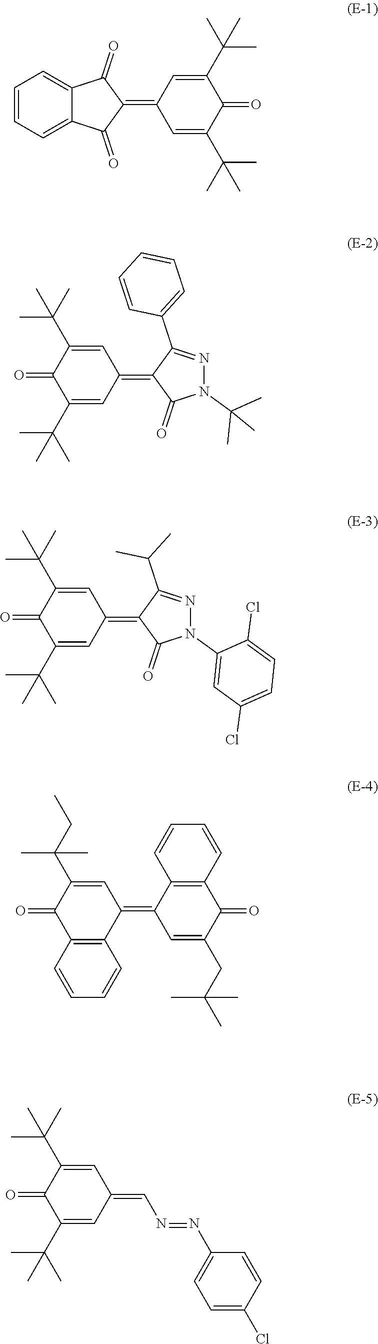 [SMILES: CC(C)(C)C1=CC(=C2C(=O)c3ccccc3C2=O)C=C(C(C)(C)C)C1=O ; CC(C)(C)C1=CC(=C2C(=O)N(C(C)(C)C)N=C2c2ccccc2)C=C(C(C)(C)C)C1=O ; CC(C)C1=NN(c2cc(Cl)ccc2Cl)C(=O)C1=C1C=C(C(C)(C)C)C(=O)C(C(C)(C)C)=C1 ; CCC(C)(C)C1=C/C(=C2/C=C(CC(C)(C)C)C(=O)c3ccccc32)c2ccccc2C1=O ; CC(C)(C)C1=CC(=C/N=N/c2ccc(Cl)cc2)C=C(C(C)(C)C)C1=O]

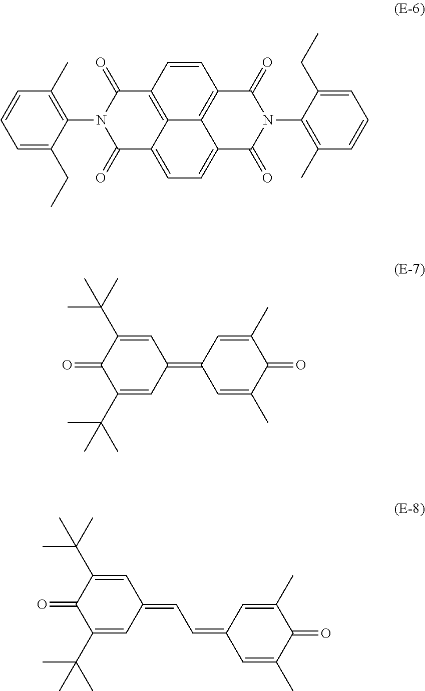 [SMILES: CCc1cccc(C)c1N1C(=O)c2ccc3c4c(ccc(c24)C1=O)C(=O)N(c1c(C)cccc1CC)C3=O ; CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O]

11. The electrophotographic photosensitive member according to claim 1, wherein the photosensitive layer contains, as an additive, at least one compound selected from the group consisting of: a compound represented by the following formula (T-1); a compound represented by the following formula (T-2); a compound represented by the following formula (T-3); and a compound represented by the following formula (T-4).

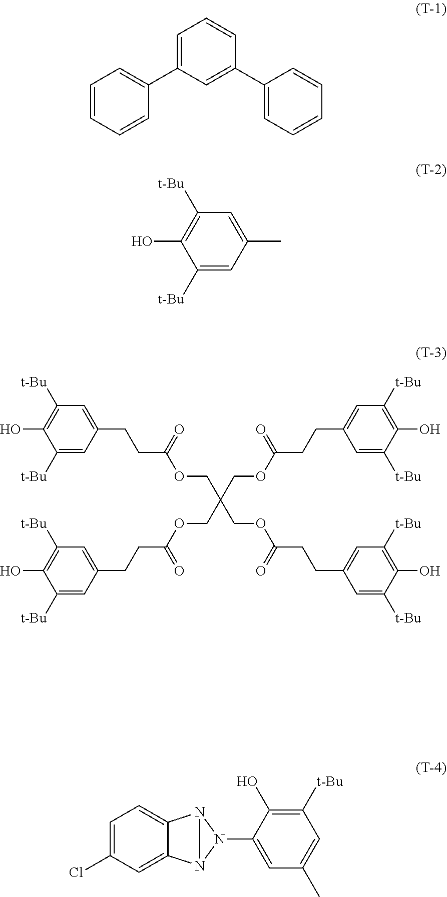

12. A process cartridge comprising:
an electrophotographic photosensitive member; and at least one unit selected from the group consisting of: a charging unit; a developing unit; and a cleaning unit,
the process cartridge integrally supporting the electrophotographic photosensitive member and the at least one unit, and being detachably attachable onto a main body of an electrophotographic apparatus,
the electrophotographic photosensitive member comprising:
a support; and
a photosensitive layer,
wherein the photosensitive layer contains a binder resin, a charge generating material, an electron transporting material, and a hole transporting material,
wherein the binder resin contains a polyarylate resin having a structural unit represented by the following formula (1), a structural unit represented by the following formula (2), a structural unit represented by the following formula (3), and a structural unit represented by the following formula (4): 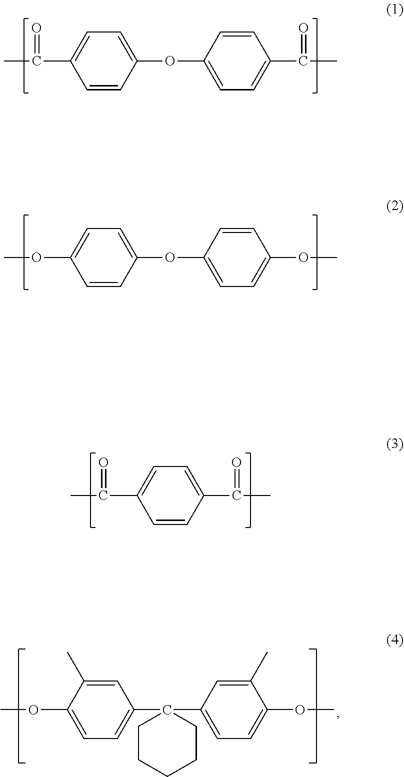
and
wherein the hole transporting material contains a compound represented by the following formula (5): 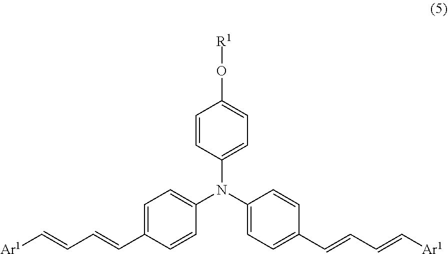
in the formula (5), R¹ represents an alkyl group having 2 or more and 4 or less carbon atoms, and Ar¹ represents an aryl group that may have an alkyl group having 1 or more and 4 or less carbon atoms as a substituent.

13. The process cartridge according to claim 12,
wherein the process cartridge comprises the charging unit, and
wherein the charging unit is a charging unit configured to positively charge the electrophotographic photosensitive member.

14. An electrophotographic apparatus comprising:
an electrophotographic photosensitive member;
a charging unit;
an exposing unit;
a developing unit; and
a transfer unit,
the electrophotographic photosensitive member comprising:
a support; and
a photosensitive layer,
wherein the photosensitive layer contains a binder resin, a charge generating material, an electron transporting material, and a hole transporting material,
wherein the binder resin contains a polyarylate resin having a structural unit represented by the following formula (1), a structural unit represented by the following formula (2), a structural unit represented by the following formula (3), and a structural unit represented by the following formula (4): 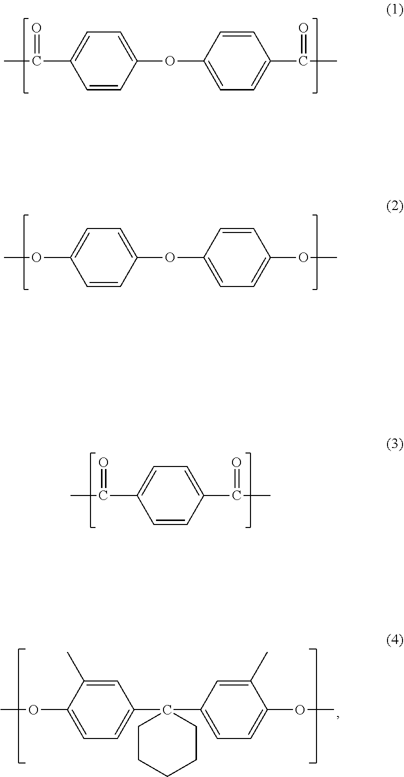
and
wherein the hole transporting material contains a compound represented by the following formula (5): 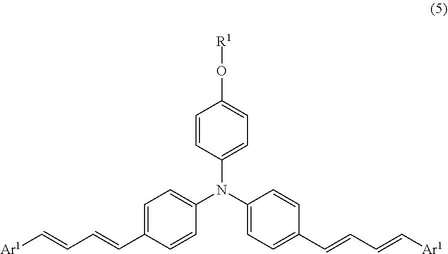
in the formula (5), R¹ represents an alkyl group having 2 or more and 4 or less carbon atoms, and Ar¹ represents an aryl group that may have an alkyl group having 1 or more and 4 or less carbon atoms as a substituent.

15. The electrophotographic apparatus according to claim 14, wherein the charging unit is a charging unit configured to positively charge the electrophotographic photosensitive member.
